(19) United States
(12) Patent Application Publication
(10) Pub. No.: US 2009/0031030 A1
(43) Pub. Date: Jan. 29, 2009

(54) PEER-BASED NETWORKING ENVIRONMENT

(76) Inventor: Raymond J. Schmidt, Troy, NY (US)

Correspondence Address: HOFFMAN WARNICK LLC, 75 STATE STREET, 14TH FLOOR, ALBANY, NY, 12207, US

(21) Appl. No.: 12/179,678

(22) Filed: Jul. 25, 2008

Related U.S. Application Data
(60) Provisional application No. 60/951,829, filed on Jul. 25, 2007.

(51) Int. Cl. G06F 15/16; G06F 7/04

(52) U.S. Cl. 709/227; 726/5

(57) ABSTRACT

A solution for providing a networking environment is provided, in which data for a plurality of members is managed. Each member includes profile data and may include one or more peers. A peer can comprise another member that is a friend of the member. The member can provide invitee credentials, such as an identifier (e.g., user name) and password, which another member can use to view some or all of the profile data of the member. Additionally, peers of the other member can also view some or all of the profile data of the member and both the other member and his/her peers can view some or all of the profile data of the peer(s) of the member. In this manner, a networking environment is provided that enables an individual and his/her peers to learn about another individual in the context of the other individual's peers.

### REFERENCE TO PRIOR APPLICATIONS

The current application claims the benefit of co-pending U.S. Provisional Application No. 60/951,829, titled “Peer-Based Networking Environment”, which was filed on 25 Jul. 2007, and which is hereby incorporated by reference.

### TECHNICAL FIELD

The disclosure relates generally to social networking, and more particularly, to an electronic social networking environment.

### BACKGROUND ART

In current electronic markets, information is typically disseminated in a public, “post and pray” type solution. That is, a user posts his/her information, and it is available for all and/or all other registered users to view. Such an approach fails to provide the posting user with any assurances regarding the viewing users and fails to provide the viewing user with any assurances regarding the accuracy of the posted information. Further, the posting/viewing users may be geographically separated by a large distance, making in-person substantiation of one another and/or the information difficult.

Similar problems exist in current electronic social/business networking (e.g., friendship/dating) approaches. In particular, it can be difficult for a user to determine the relevancy, compatibility, credibility, and trust of another user and the information being provided. As a result, a potentially costly in-person meeting (e.g., due to geographic separation) also can pose a safety risk to an individual.

Outside of the electronic environment, people rely on social networking to address many of the above issues. As a person's social/business network expands, so does the probability that an individual within the network will prove to be useful in resolving a problem. A diverse and influential social/business network can be most beneficial in nurturing an individual's private/personal aspirations and advancing his/her professional goals. Current electronic dating/social utility approaches attempt to match individuals based on physical attributes, geographic locations, personalities, and/or the like. However, these solutions do not accurately account for the complexity of the human brain and the emotions and imaginations of people and fail to exploit traditional approaches for meeting new people.

### SUMMARY OF THE INVENTION

In light of the above, quality social/business contacts can be difficult to discover and cultivate in the electronic environment using the current approaches.

To this extent, aspects of the invention provide an electronic social networking solution that enables users to use traditional social networking techniques in an electronic environment. In particular, aspects of the invention provide a networking environment, in which data for a plurality of members is managed. Each member includes profile data and may include one or more peers. A peer can comprise another member that is a friend, colleague, and/or the like, of the member. The member can provide invitee credentials, such as an identifier (e.g., user name) and password, which another member can use to view some or all of the profile data of the member. Additionally, peers of the other member can also view some or all of the profile data of the member and both the other member and his/her peers can view some or all of the profile data of the peer(s) of the member. In this manner, a networking environment is provided that enables an individual and his/her peers to learn about another individual in the context of the other individual's peers.

A first aspect of the invention provides a method of providing a networking environment, the method comprising: managing data for a plurality of members, each member including profile data that cannot be viewed by other members without a relationship between the members; receiving invitee credentials for viewing profile data of a first member from a second member; enabling the second member to view the profile data of the first member in response to the invitee credentials; and enabling a third member to view the profile data of the first member in response to the invitee credentials, wherein relationship data defines the third member as a peer of the second member.

A second aspect of the invention provides a system for providing a networking environment, the system comprising: a component configured to manage data for a plurality of members, each member including profile data that cannot be viewed by other members without a relationship between the members; a component configured to receive invitee credentials for viewing profile data of a first member from a second member; a component configured to enable the second member to view the profile data of the first member in response to the invitee credentials; and a component configured to enable a third member to view the profile data of the first member in response to the invitee credentials, wherein relationship data defines the third member as a peer of the second member.

A third aspect of the invention provides a computer program comprising program code stored on a computer-readable medium, which when executed, enables a computer system to implement a method of providing a networking environment, the method comprising: managing data for a plurality of members, each member including profile data that cannot be viewed by other members without a relationship between the members; receiving invitee credentials for viewing profile data of a first member from a second member; and storing relationship data indicating that the first member is a direct portrait of the second member, wherein the relationship data enables the second member to view the profile data of the first member, and enables a third member to view the profile data of the first member, wherein relationship data defines the third member as a peer of the second member.

A fourth aspect of the invention provides a method of generating a system for providing a networking environment, the method comprising: providing a computer system operable to: manage data for a plurality of members, each member including profile data that cannot be viewed by other members without a relationship between the members; receive invitee credentials for viewing profile data of a first member from a second member; enable the second member to view the profile data of the first member in response to the invitee credentials; and enable a third member to view the profile data of the first member in response to the invitee credentials, wherein relationship data defines the third member as a peer of the second member.

A fifth aspect of the invention provides a method comprising: at least one of providing or receiving a copy of a computer program that is embodied in a set of data signals, wherein the computer program enables a computer system to implement a method of providing a networking environment, the method comprising: managing data for a plurality of members, each member including profile data that cannot be viewed by other members without a relationship between the members; receiving invitee credentials for viewing profile data of a first member from a second member; enabling the second member to view the profile data of the first member in response to the invitee credentials; and enabling a third member to view the profile data of the first member in response to the invitee credentials, wherein relationship data defines the third member as a peer of the second member.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for providing a networking environment according to an embodiment.

FIGS. 2A-D show an illustrative series of interactions between members of the networking environment according to an embodiment.

FIGS. 3A-D show an illustrative series of communication abilities between the members shown in FIGS. 2A-D according to an embodiment.

FIG. 4 shows an illustrative table for storing events according to an embodiment.

FIG. 5 shows an illustrative profile page according to an embodiment.

FIG. 6 shows an illustrative peer page according to an embodiment.

FIG. 7 shows an illustrative member page according to an embodiment.

FIG. 8 shows an illustrative relationships page according to an embodiment.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a networking environment, in which data for a plurality of members is managed. Each member includes profile data and may include one or more peers. A peer can comprise another member that is a friend, colleague, and/or the like, of the member. The member can provide invitee credentials, such as an identifier (e.g., user name) and password, which another member can use to view some or all of the profile data of the member. Additionally, peers of the other member can also view some or all of the profile data of the member and both the other member and his/her peers can view some or all of the profile data of the peer(s) of the member. In this manner, a networking environment is provided that enables an individual and his/her peers to learn about another individual in the context of the other individual's peers. As used herein, unless otherwise noted, the term “set” means one or more (i.e., at least one) and the phrase “any solution” means any now known or later developed solution.

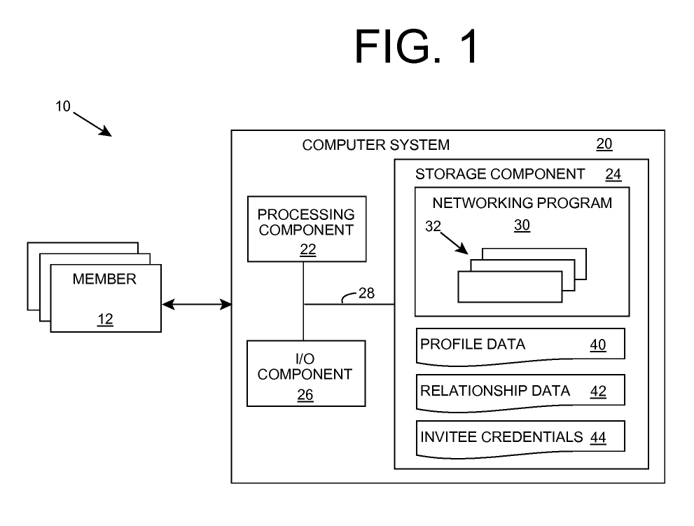

Turning to the drawings, FIG. 1 shows an illustrative environment 10 for providing a networking environment according to an embodiment. To this extent, environment 10 includes a computer system 20 that can perform the process described herein in order to provide a networking environment. In particular, computer system 20 is shown including a networking program 30, which makes computer system 20 operable to provide a networking environment by performing the process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as networking program 30, which is at least partially stored in storage component 24. While executing program code, processing component 22 can read and/or write data to/from storage component 24 and/or I/O component 26. Pathway 28 provides a communications link between each of the components in computer system 20. I/O component 26 can comprise one or more human I/O devices, which enable a human user, such as a member 12, to interact with computer system 20 and/or one or more communications devices to enable a system user (e.g., a computer system being utilized by member 12) to communicate with computer system 20 using any type of communications link. To this extent, networking program 30 can manage interaction with member(s) 12 using a human user interface (e.g., a graphical user interface (GUI)), an application program interface (API), and/or the like.

In any event, computer system 20 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, networking program 30 can be embodied as any combination of system software and/or application software.

Further, networking program 30 can be implemented using a set of modules 32, which can be distributed and/or implemented as a unit and/or as multiple, distinct units. In this case, a module 32 can enable computer system 20 to perform a set of tasks used by networking program 30, and can be separately developed and/or implemented apart from other portions of networking program 30. As used herein, the term “component” means any configuration of hardware, with or without software, which implements and/or enables a computer system 20 to implement the functionality described in conjunction therewith using any solution, while the term “module” means program code that enables a computer system 20 to implement the functionality described in conjunction therewith using any solution. When embodied in a tangible medium of expression, networking program 30, or a module 32 thereof, is a component. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, a computing device may have only a portion of networking program 30 installed thereon (e.g., one or more modules 32). However, it is understood that computer system 20 and networking program 30 are only representative of various possible equivalent computer systems that may perform the process described herein. To this extent, in other embodiments, the functionality provided by computer system 20 and networking program 30 can be at least partially implemented by one or more computing devices that include any combination of general and/or specific purpose hardware and/or program code. In each embodiment, the program code and hardware can be created using standard programming and engineering techniques, respectively.

Regardless, when computer system 20 includes multiple computing devices, the computing devices can communicate over any type of communications link. Further, while performing the process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, networking program 30 enables computer system 20 to provide a networking environment. To this extent, computer system 20 can enable one or more individuals to become members 12 and provide profile data 40 on himself/herself for storage on computer system 20 using any solution. Profile data 40 can include any combination of information on the member 12 including one or more images, text, video/audio recordings, and/or the like. Computer system 20 can manage (e.g., store, retrieve, create, manipulate, organize, present, etc.) profile data 40 using any solution (e.g., a set of databases). In an embodiment, computer system 20 can present a series of questions, which prompt member 12 for information that is required and/or is suggested for inclusion in profile data 40. Further, computer system 20 can provide security for creating and/or modifying profile data 40 using any solution (e.g., username and password). Still further, computer system 20 can verify some or all of profile data 40 entered by member 12 and/or that member 12 is a human (and not a software agent) using any solution (e.g., valid email address, valid credit card number, valid phone number, using image(s) of distorted letters/numbers, and/or the like).

In any event, member 12 can manage relationship data 42, which defines various types of relationships between member 12 and other members. For example, computer system 20 can enable member 12 to designate one or more other members 12 as “peers” using any solution, e.g., by providing an email address, a phone number, a user name for networking environment 10, and/or any other type of identifying information. A peer can comprise a friend, colleague, trusted individual, and/or the like, of member 12. In this case, computer system 20 can generate and store relationship data 42 that indicates that the two members are peers. The peer relationship data 42 can comprise a two-way relationship, in which both members 12 are peers of one another. To this extent, computer system 20 can require that both members 12 agree to be peers of one another prior to adding a peer relationship to relationship data 42. Further, depending on the action being taken (as discussed herein), each member 12 can be considered a “peer master” for the group of peers. For example, the member that is considering, taking, and/or has authority to take an action can be considered the “peer master”.

In an embodiment, members 12 interact with other members 12 via one or more pages, which render some or all of their corresponding profiles. As used herein, a member's profile comprises the member's profile data 40 and some or all of the profile data 40 of each peer (if any) of the member as defined by relationship data 42. To this extent, computer system 20 can generate a set of pages based on profile data 40 and/or relationship data 42. For example, computer system 20 can generate a profile page that includes some or all of the profile data 40 on the corresponding member 12. Further, computer system 20 can generate a peer page that includes some or all of the profile data 40 for each peer of member 12 (if any). Computer system 20 can manage relationship data 42, which defines the various relationships described herein between members 12 and enable the correct communication and/or data permissions to be applied for each member 12 using any solution (e.g., entries in a relational database).

Access to view a member's 12 profile can be limited. For example, in an embodiment, peers can view each other's profiles. However, other individuals (members or non-members) must be invited by a particular member 12 before being allowed to view his/her profile. Communications between members 12 can be managed via the profiles and restricted in a similar manner. That is, peers can communicate with one another utilizing their corresponding peer pages, a forum, and/or the like. However, a non-peer member 12 can communicate with another member 12 only when requested by the other member 12 and/or a peer of the other member 12. Alternatively, access to view some or all of a member's 12 profile can be open. In this case, another member can view some or all of a member's 12 profile without first receiving an invitation. In an embodiment, computer system 20 can limit an ability to view profiles (e.g., by default), but enable member 12 to select to make the viewing of some or all of his/her profile open. For example, member 12 may define a subset of his/her profile data 40 that can be viewed publicly, a subset of his/her profile data 40 that can be viewed by an invitee, and/or the like. When member 12 makes some or all of his/her profile data 40 publicly viewable, publicly viewable profile data 40 for a peer of member 12 may also be displayed when the profile data 40 for member 12 is presented to a user. However, if a peer of member 12 does not designate any profile data 40 as being publicly viewable, no profile data 40 for that peer will be displayed to an uninvited user.

To this extent, in order for an individual to view the profile page of a particular member 12 and/or his/her peers, the individual can be provided invitee credentials 44 using any solution. For example, a member 12 can request that computer system 20 generate invitee credentials 44. Invitee credentials 44 can comprise a user name and password combination, a hyperlink, and/or the like, which identifies and authenticates the individual and is associated with the particular member 12 for which the invitee credentials 44 were created. The invitee credentials 44 can have various restrictions. For example, invitee credentials 44 can be valid for a limited period of time after generation, a limited period of time after the first use, a limited number of uses, and/or the like. In any event, member 12, or a surrogate thereof, can distribute invitee credentials 44 to individual(s) using any solution. For example, member 12 can distribute invitee credentials 44 electronically, in a writing (e.g., a business card), via one or more friends/relatives, and/or the like. Subsequently, the invited individual can provide invitee credentials 44 to computer system 20, at which time the individual (and any of his/her peers if the individual is a member) will be provided access to the inviter's (the member 12 associated with invitee credentials 44) profile page and the profile page of each of the inviter's peers, if any.

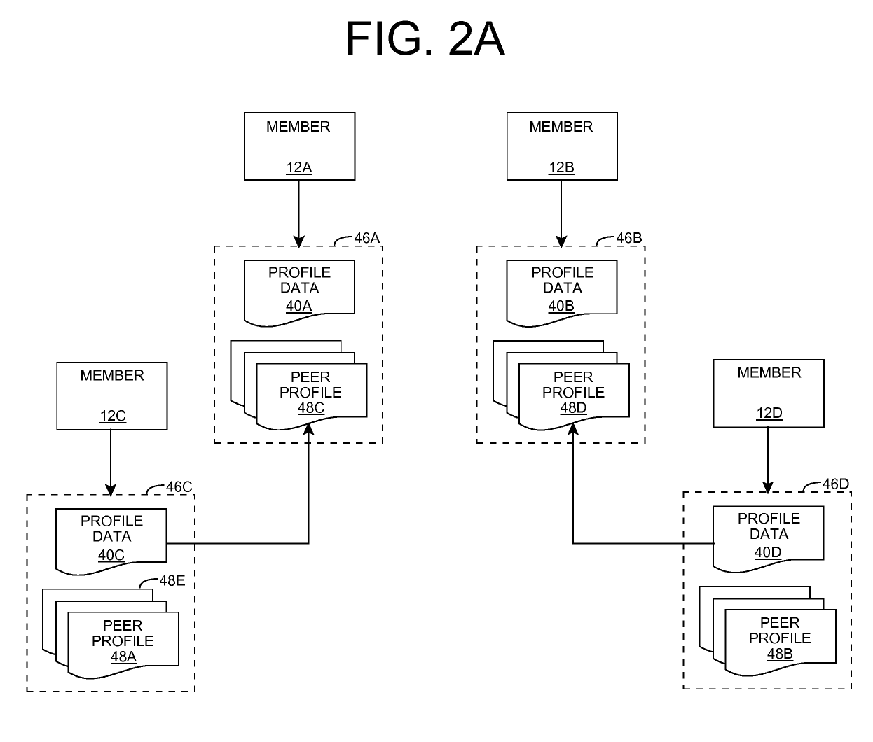

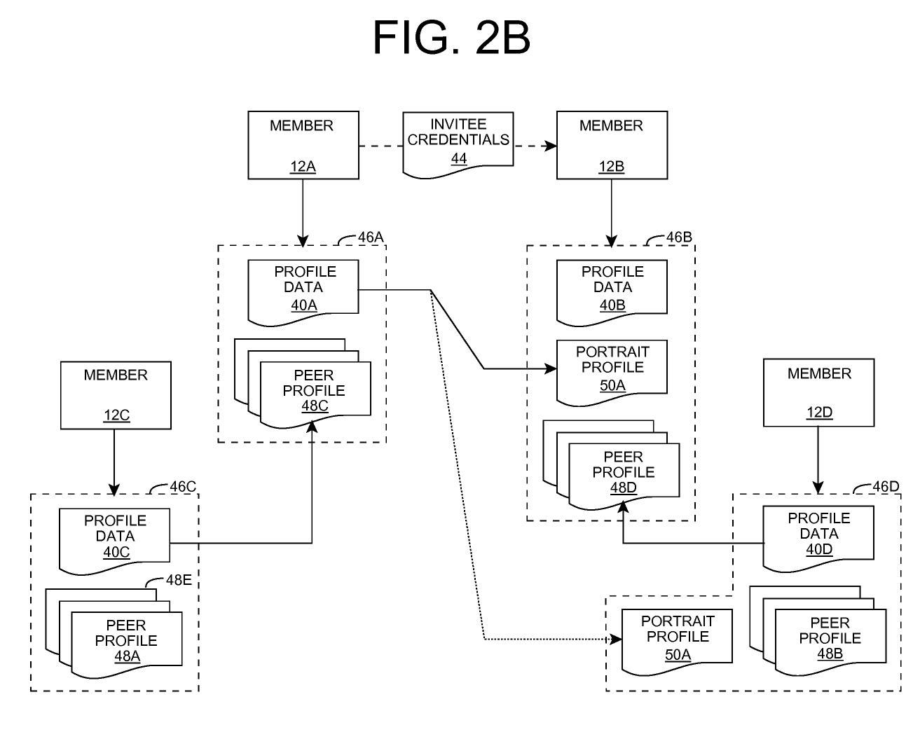

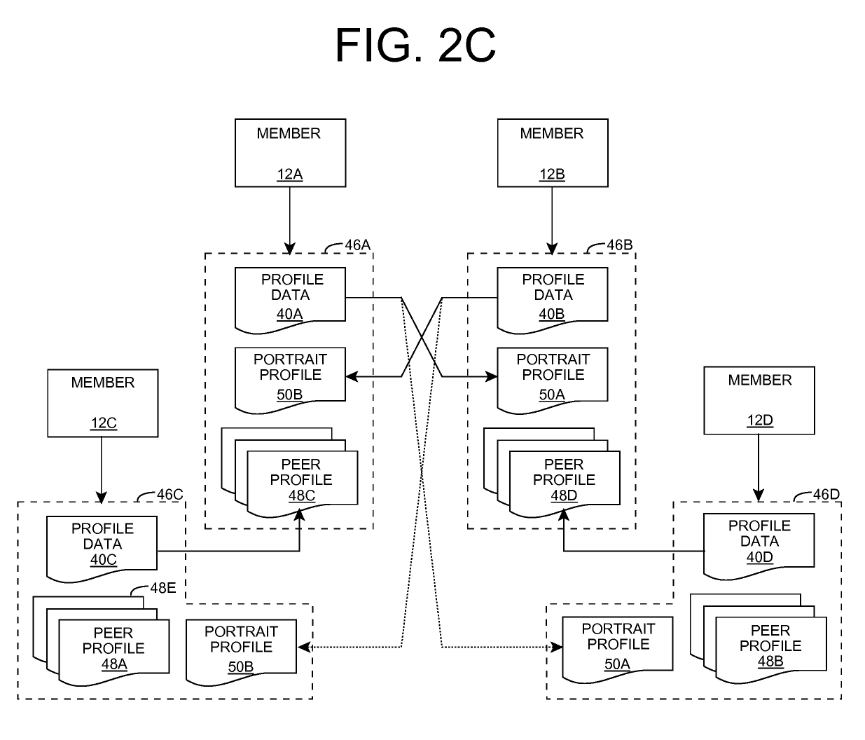

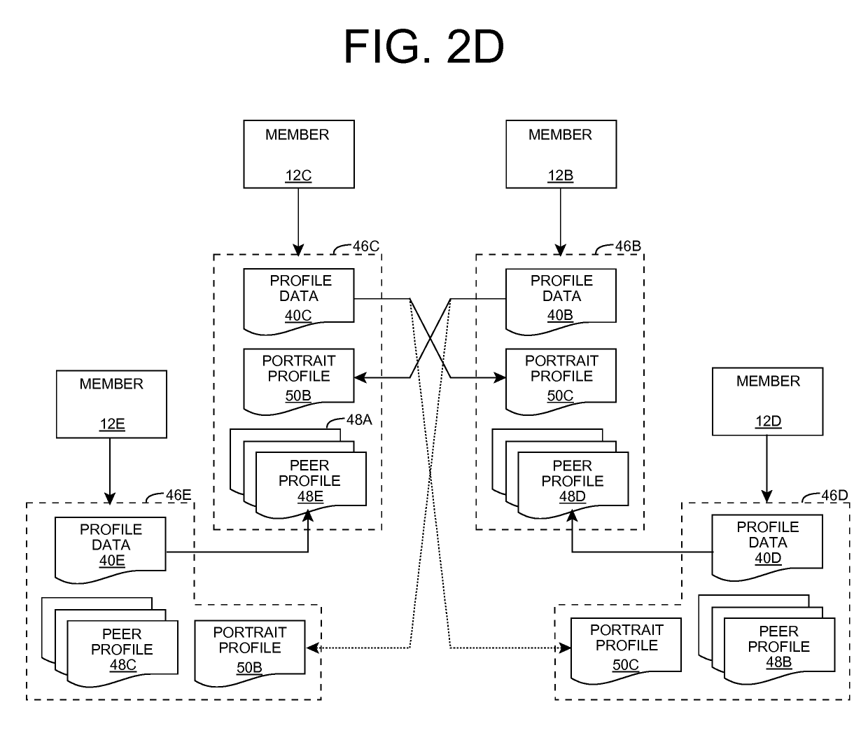

FIGS. 2A-D and 3A-D show an illustrative series of interactions and corresponding communication abilities between members 12A-E of the networking environment 10 according to an embodiment. In FIG. 2A, two distinct groups of peers are illustrated. In particular, member 12A can comprise a profile 46A that includes profile data 40A for member 12A as well as profile data, such as peer profile 48C, for one or more peers, such as member 12C, of member 12A. Similarly, member 12B comprises a profile 46B that includes profile data 40B and peer profile data 48D for member 12D, who is a peer of member 12B. Peer profiles 48C-D can comprise a subset of the data that is included in profile data 40C-D for the corresponding members 12C-D, respectively. Members 12C, 12D also are shown including similar profiles 46C, 46D, respectively. As illustrated in profile 46C, member 12C can comprise a peer (member 12E, not shown) for which peer profile 48E is included in profile 46C, but who is not a peer of member 12A.

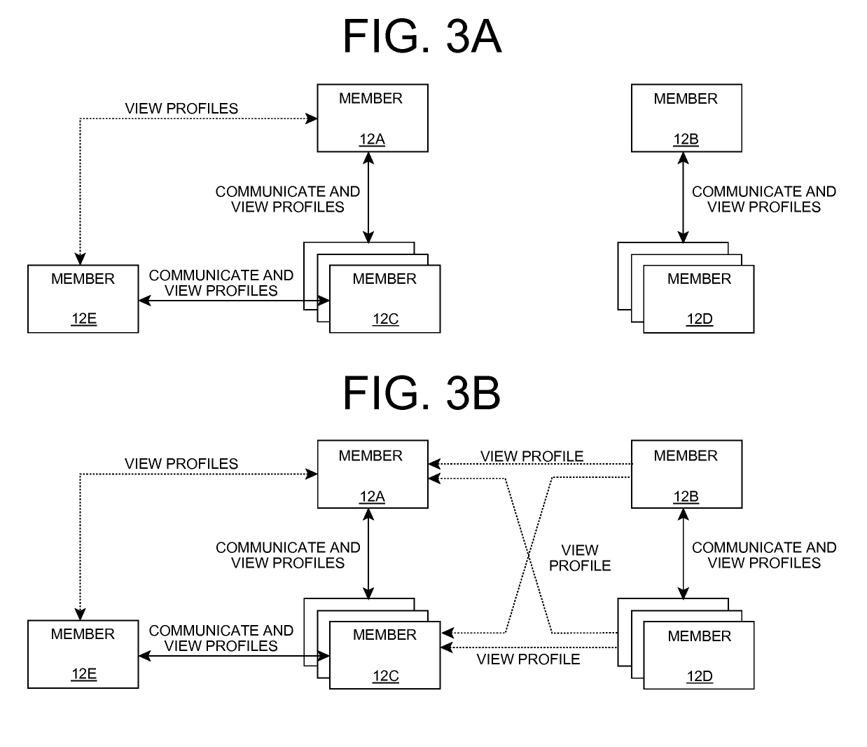

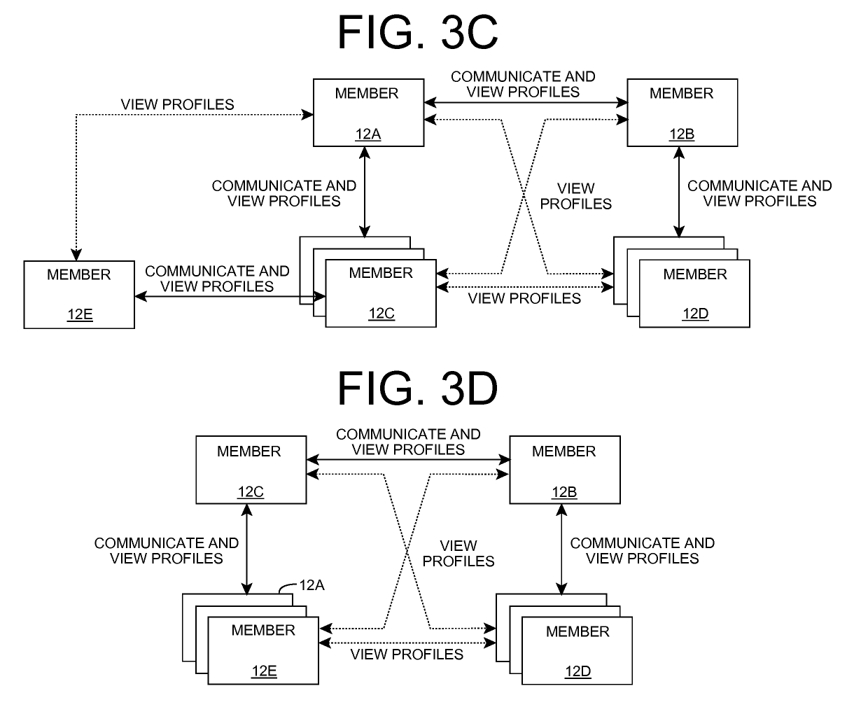

In FIG. 3A, communications between the various members 12A-E is illustrated. In particular, members 12A and 12C can communicate with one another as well as view each other's profiles since they are peers. Similarly, members 12B and 12D and members 12C and 12E can communicate with one another as well as view each other's profiles. However, members 12A, 12C, 12E cannot communicate with or view the profiles of members 12B, 12D since they are not peers and have not been requested to do so. Further, members 12A, 12E can view each other's profiles since they are both peers of member 12C (“indirect peers”), but members 12A, 12E cannot communicate with one another.

In FIG. 2B, member 12A provides invitee credentials 44 to member 12B. As discussed previously, invitee credentials 44 enable a user (member or non-member) to view some or all of the profile 46A of member 12A. Upon receiving invitee credentials 44 from the user, computer system 20 can enable the user to view profile 46A. Additionally, when the user is a member, such as member 12B, invitee credentials 44 can comprise an invitation to exchange profiles with one another, thereby expanding the number of contacts for each member 12A-B and their corresponding peers 12C-D. To this extent, after receiving invitee credentials 44, computer system 20 can add profile data 40A for the inviter (member 12A) to member's 12B profile 46B as a portrait profile 50A using any solution. For example, computer system 20 can generate and store relationship data 42 (FIG. 1) that defines a portrait relationship between members 12A and 12B. In an embodiment, the portrait relationship is a one way relationship (e.g., member 12A is a portrait of member 12B, but member 12B is not a portrait of member 12A as a result of the invitation). Further, until an exchange is accepted/declined, the relationship data 42 can indicate that the portrait relationship is temporary, pending acceptance, and/or the like. Each portrait profile 50A can comprise a subset of profile data 40A for a corresponding member 12A that has directly or indirectly invited the member 12B to view his/her profile 46A and exchange profiles. Computer system 20 (FIG. 1) can generate a separate page (“portrait page”) for displaying portrait profile(s) 50A for a member 12B. Viewing of the portrait page for a particular member 12B can be limited to the particular member 12B, and may or may not be accessible by other members including the peers of the member 12B.

As illustrated, computer system 20 also can add a portrait profile 50A to the profile, such as profile 46D, of each peer of member 12B, such as member 12D, using any solution. For example, computer system 20 can traverse relationship data 42 (FIG. 1) to identify every direct portrait of the peer(s) of member 12D, such as member 12B, and add the portrait profile(s), if any, (e.g., portrait profile 50A) to the profile of member 12D. As a result, computer system 20 can enable each peer of member 12B to view the profile 46A of member 12A. To this extent, portrait profile(s) 50A for a member can be classified by those that appear due to direct interaction with the member (e.g., “direct portrait”) and those that appear due to interaction with a peer of the member (e.g., “indirect portrait”). Further, communication privileges can be different for the two classifications. For example, a member may be able to communicate with a member that comprises a “direct portrait”, but not be able to communicate with a member that comprises an “indirect portrait”.

As illustrated in FIG. 3B, upon entry of the invitee credentials 44 (e.g., acceptance of the invitation), computer system 20 enables member 12B and member's peers, such as member 12D, to view some or all of the profile (profile data and peer profile(s)) of member 12A. Additionally, members 12B, 12D can view some or all of the profile(s) of the peers of member 12A, such as member 12C. In an embodiment, the members 12B, 12D can not view the peers of the inviter's peers (e.g., member 12E). Alternatively, members 12B, 12D can be allowed to view the peers of the inviter's peers. However, members 12A, 12C cannot yet view the profiles of members 12B, 12D. In an embodiment, member 12B and member 12A cannot communicate with one another. Alternatively, member 12B could communicate with member 12A, while member 12A could not communicate with member 12B unless as part of a communication initiated by member 12B.

At this point, member 12B can consider whether or not to accept the invitation to exchange profiles with member 12A. To this extent, member 12B can consider the invitation without having exchanged any personal information with member 12A. Further, member 12A and his/her peers cannot view any of member 12B and/or his/her peers' profiles as a result of accepting the invitation. The invitee credentials 44 can require that member 12B accept/reject the invitation within a designated period of time. If member 12B does not take any action prior to the end of the period, member 12B can be presumed to have rejected the invitation. Regardless, in an embodiment, while member 12B is considering the exchange (or after the exchange is accepted), member 12B and/or one or more of his/her peers can request an exchange with member 12A and/or one or more of his/her peers, such as member 12C. Alternatively, member 12B and/or one or more of his/her peers cannot request an exchange with member 12A and/or one or more of his/her peers until member 12B has accepted the exchange with member 12A.

Computer system 20 (FIG. 1) can enable peers to communicate amongst each other using any solution(s). For example, computer system 20 can manage communications between members 12B, 12D via text messages, a chat room, email, telephone, and/or the like. The peers can discuss the inviter (e.g., member 12A) with the invitee (e.g., member 12B) and recommend whether the invitee should exchange his/her profile with the inviter.

In FIG. 2C, member 12B exchanges profiles with member 12A. As a result, computer system 20 can generate and store relationship data 42 (FIG. 1) that indicates that members 12A, 12B have exchanged profiles. For example, computer system 20 can generate and store relationship data 42 that indicates that both members 12A, 12B are direct portraits of each other. Further, using relationship data 42, computer system 20 adds the portrait profile 50A-B for each member 12A-B to the other member's profile 46B-A, respectively, and computer system 20 also adds portrait profiles 50A-B to the profiles 46D-C of the other member's peer(s), respectively. As illustrated in FIG. 3C, members 12A-B can now communicate with each other and view each other's profiles. Further, each member 12A-B and the peers of each member, members 12C-D, can view the profiles of the other member and his/her peers. In an embodiment, the members 12B, 12D can not view the peers of the exchanged member's 12A peers (e.g., member 12E). Alternatively, members 12B, 12D can be allowed to view the peers of the exchanged member's 12A peers.

FIG. 2D illustrates a scenario in which member 12B, after receiving an invitation from member 12A (FIG. 2B), decides to exchange with member 12C, a peer of member 12A, and member 12C accepts the exchange. In this case, computer system 20 adds relationship data 42 (FIG. 1) that indicates that members 12B, 12C have exchanged profiles (e.g., both are direct portraits). Further, computer system 20 adds the portrait profiles 50B-C to the corresponding portraits 46C-B, respectively, and computer system 20 adds portrait profile 50B to the peers of member 12C, e.g., members 12A, 12E. As illustrated in FIG. 3D, members 12B-C can communicate with one another and view their respective profiles, while the peers of member 12C, which includes both members 12A, 12E, can view the profiles of member 12B and his/her peers 12D and vice versa.

Over time, relationships between members 12A-E may change. To this extent, computer system 20 can enable a member 12A-E to change a classification of a member (e.g., from a “portrait” to a “peer”). Further, computer system 20 can enable a relationship to terminate (e.g., member 12C can drop member 12B as a portrait). In either case, computer system 20 can update relationship data 42 (FIG. 1) to reflect the change(s). Additionally, computer system 20 can update the profiles of the members and their peers to reflect the changed relationship. When a member, e.g., member 12C, seeks to move another member, e.g., member 12B, to a higher classification (e.g., from portrait to peer), computer system 20 can require that both members 12B-C agree to the change, since such an increase will mean further distribution of the other member's 12B-C data at the discretion of the member 12C-B (e.g., member 12B's data will be made available to invitee's of member 12C and vice versa).

When relationships between members are terminated, it can result in a portrait being removed from a member's profile. For example, if the relationship between members 12B-C is terminated, then the inclusion of portrait profile 50B in profile 46E will be removed. However, a member may have multiple paths to the same portrait profile. For example, even after terminating the relationship, portrait profile 50B could still appear on profile 46C as an “indirect portrait” if members 12A-B exchanged profiles since member 12C is a peer of member 12A. In this case, computer system 20 can remove the portrait profile 50B (e.g., allow the terminated relationship to overrule the indirect relationship) or keep portrait profile 50B as an indirect portrait.

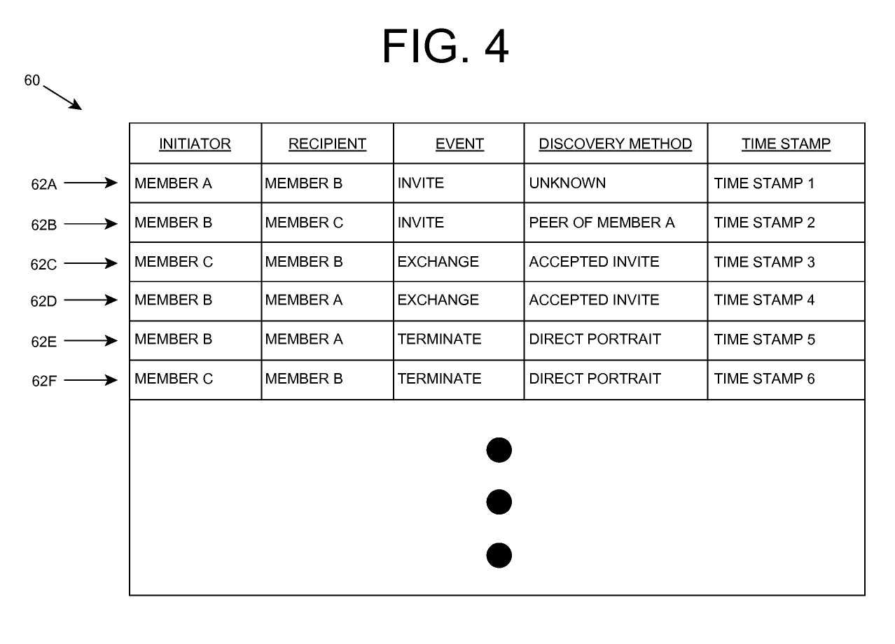

In an embodiment, computer system 20 can enable a member to determine a chain of events that led to another member being included as a direct or indirect portrait. To this extent, FIG. 4 shows an illustrative table 60 for storing events 62A-F according to an embodiment. In particular, computer system 20 can store, for each event 62A-F, an initiating member (“Initiator”) a receiving member (“Recipient”), an event type, a discovery method (e.g., the way that the initiator learned about the recipient), and a time stamp. It is understood that this data is only illustrative and different configurations of data using more and/or less fields are possible under the disclosure. In any event, computer system 20 can construct and display a path/chain of events using a linked list, and/or the like, which enables a member to determine how another member appeared as a direct/indirect portrait of the member.

In the illustrative scenario: MEMBERS A, C, and F are peers of one another; MEMBERS B and D are peers of one another; and MEMBERS E and C are peers one another, but MEMBER E is not a peer of MEMBER A or F. In this case, MEMBER A is a peer master of a peer group that also includes MEMBERS C, F; MEMBER B is a peer master of a group that also includes MEMBER D; MEMBER C is a peer master of a group that also includes MEMBERS A, E, F; MEMBER D is a peer master of a group that also includes MEMBER B; MEMBER E is a peer master of a group that also includes MEMBER C; and MEMBER F is a peer master of a group that also includes MEMBERS A, C.

Assuming events 62A-F occurred chronologically, after event 62A, MEMBER D acquires MEMBER A as an indirect portrait and MEMBER B acquires MEMBER A as a direct portrait; and after event 62B, MEMBERS A, F, and E acquire MEMBER B as an indirect portrait and MEMBER C acquires MEMBER B as a direct portrait. After event 62C, MEMBER D acquires MEMBER C as an indirect portrait and MEMBER B acquires MEMBER C as a direct portrait; and after event 62D, MEMBER A acquires MEMBER B as a direct portrait (and MEMBER B is removed as an indirect portrait of MEMBER A), MEMBER C would acquire MEMBER B as an indirect portrait, but MEMBER B is already included as a direct portrait, and MEMBER F would acquire MEMBER B as an indirect portrait, but MEMBER B is already an indirect portrait of MEMBER F due to event 62B.

Event 62A enables MEMBER B and his/her peers to access the profile data of MEMBER A and his/her peers. Event 62D enables MEMBER A and his/her peers to access the profile data of MEMBER B and his/her peers. Similarly, event 62B enables MEMBER C and his/her peers to access the profile data of MEMBER B and his/her peers. Event 62C enables MEMBER B and his/her peers to access the profile data of MEMBER C and his/her peers. However, access to the profile data can be altered when one or more relationships/exchanges are terminated.

To this extent, after event 62E, MEMBERS A, B are no longer direct portraits. Using MEMBER A as an illustrative example, computer system 20 (FIG. 1) removes MEMBER B from his/her portrait page. However, computer system 20 also can determine if a peer of MEMBER A includes MEMBER B as a direct portrait. If so, computer system 20 can re-admit MEMBER B as an indirect portrait using the alternative path. In this example, MEMBER C, a peer of MEMBER A, has MEMBER B as a direct portrait. As a result, computer system 20 can re-admit MEMBER B as an indirect portrait of MEMBER A. Alternatively, computer system 20 can allow the termination to overrule the indirect path and keep MEMBER B off of MEMBER A's portrait page.

Computer system 20 can perform a similar process for each peer of MEMBERS A, B. For example, using MEMBERS C, F as illustrative peers, computer system 20 determines whether MEMBER B is a direct/indirect portrait of the peer. If MEMBER B is a direct portrait, as for MEMBER C, computer system 20 will leave MEMBER B on the portrait page. However, if MEMBER B is an indirect portrait, as for MEMBER F, computer system 20 will determine if MEMBER F acquired MEMBER B as an indirect portrait through MEMBER A. In an embodiment, event 62B could comprise the event that adds MEMBER B as an indirect portrait. Alternatively, event 62A could be considered the earliest event, although MEMBER B was not added due to this event until after event 62D. In any event, if MEMBER B was added as an indirect portrait through MEMBER A, MEMBER B is removed as an indirect portrait. Otherwise, MEMBER B will remain as an indirect portrait. Additionally, when MEMBER B is removed, computer system 20 also can determine if another peer of MEMBER F includes MEMBER B as a direct portrait (e.g., MEMBER C). If so, MEMBER B can be re-admitted as an indirect portrait of MEMBER F using the alternative path.

Assuming no events other than events 62A-F, after event 62F, MEMBERS B and C are removed as direct portraits of one another, MEMBER B is removed as an indirect portrait of MEMBERS E, F (and MEMBER A, if re-admitted after event 62E), and MEMBER C is removed as an indirect portrait of MEMBER D. When a member remains as an indirect portrait despite one or more terminated exchanges (e.g., due to other exchanges), computer system 20 can display an indication that one or more terminated exchanges have occurred in the direct/indirect and/or an alternative chain of events, which may be interpreted by the member as a warning sign of trustworthiness, compatibility, and/or the like. Further, computer system 20 can retain a chain of events, such as events 62A, D, E after the termination for potential future reference. For example, when a member re-discovers or previously discovered (and exchanged with) another member through a different chain of events, computer system 20 can display an indication of the previous chain of events and the termination. Further, it is understood that a member terminating a peer relationship can be processed in a similar manner as the terminated exchanges discussed herein.

Returning to FIG. 1, additional details are now discussed with reference to some illustrative actions performed by a user, such as a member 12 using computer system 20, which provides a web site for users to utilize the networking environment.

To create a user account, a potential member can visit a home page provided by computer system 20 and elect to join. Computer system 20 will provide a web page requesting that the potential member provide his/her first and last names and a valid email address. Computer system 20 can send a validation email to the email address with an initial password for continuing with the registration to confirm the email address. Alternatively, the validation email can include a validation link, which will enable the potential member to continue with the registration. Assuming the email is valid, the potential member enters the password and computer system 20 can subject the potential member to a Completely Automated Public Turing test to tell Computers and Humans Apart (CAPTCHA), such as a rendering of distorted letters/numbers or the like, to ensure that t is a human user and not a software agent. Further, computer system 20 can perform additional identity check(s), e.g., confirm credit card information (if required to maintain an account/authenticate age), look up a given phone number for owner information, and/or the like.

Assuming the CAPTCHA is successfully passed, the user account is created. The user can be asked to provide a unique user name and/or password for the account (with retries if necessary). Once complete, computer system 20 can prompt member 12 for his/her profile data 40, e.g., by presenting a series of questions (e.g., home address, age, interests, etc.), obtaining alternative contact information (e.g., other email addresses, phone numbers, and/or the like), enabling images/video to be uploaded designating a primary image, and/or the like. Additionally, computer system 20 can enable member 12 to add one or more peers. Member 12 can identify his/her peers by an account name for networking environment 10, an email address, a phone number, and/or the like. Computer system 20 will attempt to match another member with the information provided. If a match is found, computer system 20 will ask the member if he/she wants to be a peer of member 12. If so, the peer relationship is established and stored as relationship data 42. It no member is found, computer system 20 can contact the individual and can provide the individual with invitee credentials 44, which will enable the individual to view the new member's profile as well as peruse the web site, and decide whether he/she wishes to join. Subsequently, member 12 can later return and manage his/her information (e.g., profile data 40 and peers).

As mentioned previously, computer system 20 can limit access to profile data 40. To this extent, member 12 (or an acquaintance of member 12) can provide invitee credentials 44 to a potential peer of member 12 and/or a potential acquaintance using any solution. In either case, the invitee credentials 44 can be uniquely created for each member 12 and include a user name and password. Invitee credentials 44 may be equipped with attribute(s) that specify a maximum number of usages/views, an expiration date, a counter to allow the inviter to determine if the invitee credentials 44 are being used or abused, and/or the like. Alternatively, invitee credentials 44 could comprise a link, which will enable a user to view the profile data 40 of member 12. Further, when invitee credentials 44 are provided to another member, the member's main web page can include an indicator of the invitation, which can enable the member to take action on the invitation.

In any event, when invitee credentials 44 are provided to computer system 20, computer system 20 can enable the user to view some or all of profile data 40 of the associated member 12 as well as his/her peer(s), if any. When the user is identified as a member of the networking environment 10, member 12 can be added as a direct portrait of the user (and an indirect portrait of his/her peers), the user (and his/her peers) also can view some or all of the profile data 40 of each peer, the user (and his/her peers) can request exchange(s) with member 12 and/or his/her peers, and/or the like. Otherwise, the user can be prompted to create an account.

When invitee credentials 44 are provided to another member and the other member enters invitee credentials 44, the inviter (e.g., member 12) is added as a direct portrait to the invitee's portraits and as an indirect portrait the portraits of the invitee's peer(s). Computer system 20 can enable the invitee and his/her peers to view the profile data 40 of the inviter, his/her peers, and the profile data 40 of the inviter's peers. Further, computer system 20 can provide a discussion area (e.g., instant messaging, forum, and/or the like) for the invitee and his/her peers to discuss the invitation.

Subsequently, the invitee and/or his/her peer may request an exchange with the inviter and/or one of his/her peers. Upon the request, the inviter and his/her peers can view and discuss the profile data 40 of the member requesting the exchange (e.g., the invitee and his/her peers or the peer and his/her peers). Upon acceptance of an exchange, the two members that exchanged can communicate with one another using computer system 20. However, absent a direct exchange, the respective peers cannot communicate with one another or the other member of the exchange (although they can view each other's profile data 40).

In this manner, there are five ways for a member 12 to discover new acquaintances. First, member 12 can initiate an exchange, e.g., by providing another with invitee credentials 44, at which point the other individual will be added as a direct portrait. Second, a peer of member 12 can initiate an exchange, at which point the other individual will be added as an indirect portrait. Third, another member can initiate an exchange with member 12, at which point the other member is added as a direct portrait. Fourth, another member can initiate an exchange with a peer of member 12, at which point the other member is added as an indirect portrait. Fifth, a peer of member 12 could add a new peer, at which point the new peer is added as an indirect peer. As a result, of the five methods, four are passive and only the first requires initial action on the part of member 12.

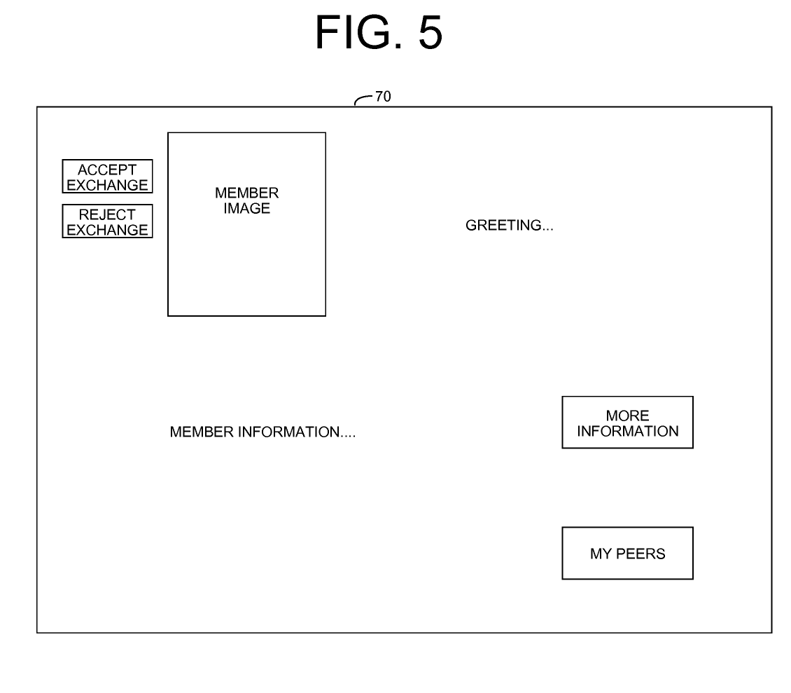

FIG. 5 shows an illustrative profile page 70 according to an embodiment, which can be generated by computer system 20 (FIG. 1). As illustrated, profile page 70 can include a primary image, a greeting, some member information, and/or the like. If available, profile page 70 can enable a user to access additional information (e.g., more pictures, additional biography, etc.). Further, profile page 70 can enable the user to access the peers of the member. Still further, when profile page 70 is presented to a member that has been invited to exchange with the member owning profile page 70, profile page 70 can enable the viewing member to accept/reject the exchange. Alternatively, when no exchange has been invited and the member owning profile page 70 is not a peer or direct profile, profile page 70 can enable the viewing member to initiate an invitation. It is understood that profile page 70 is only illustrative and additional/different functionality can be included, e.g., accept/request exchange, edit information, which can be included for the member when he/she accesses profile page 70, and/or the like.

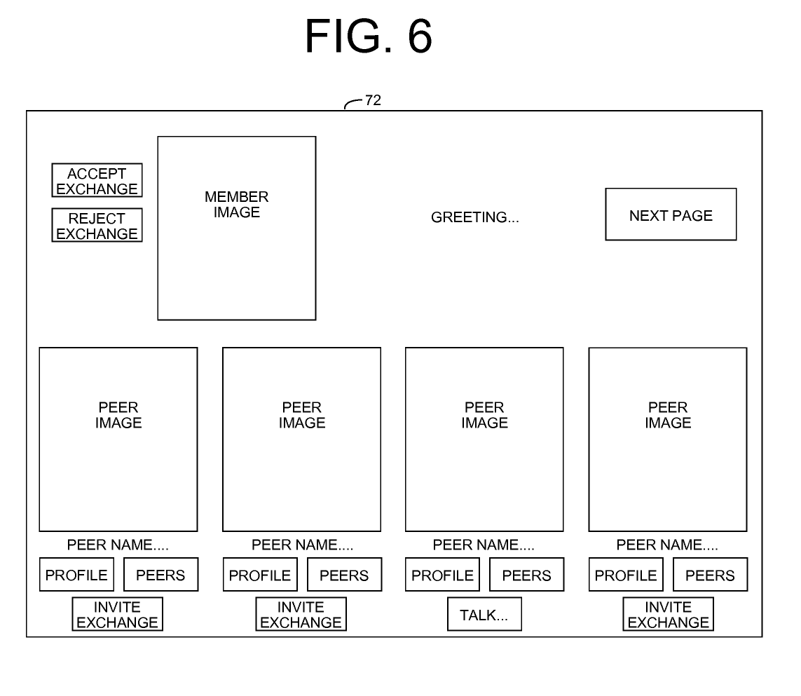

FIG. 6 shows an illustrative peer page 72 according to an embodiment, which can be generated by computer system 20 (FIG. 1). Peer page 72 can include an image of the member whose peers are being displayed as well as a peer page greeting. Further, peer page 72 can include an image of a peer, his/her name (e.g., first name), and/or other data, and enable a user to view the corresponding profile and/or peers of each peer. Further, if the user has already directly exchanged with one of the peers, peer page 72 can enable the user to communicate with the peer (e.g., “talk . . . ”). Alternatively, peer page 72 can enable the user to initiate an invitation with one or more of the members being displayed, accept/reject an invitation to exchange, and/or the like. It is understood that peer page 72 is only illustrative and additional/different functionality can be included.

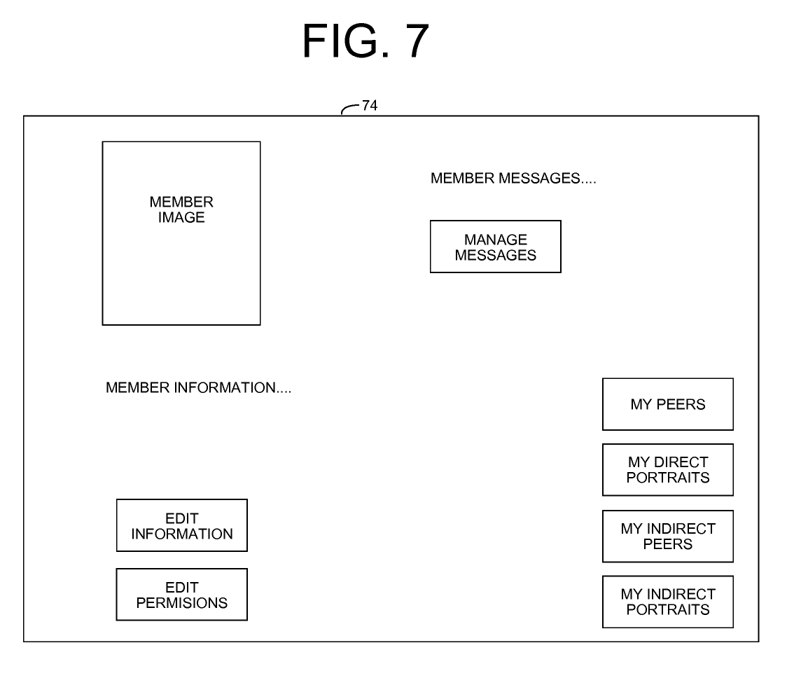

FIG. 7 shows an illustrative member page 74 according to an embodiment, which can be generated by computer system 20 (FIG. 1). Computer system 20 can provide member page 74 to a member 12 (FIG. 1) to enable member 12 to manage his/her profile (e.g., profile data 40 and relationships). As illustrated, member page 74 can enable member 12 to edit his/her profile data 40 (e.g., edit information), view/respond to messages received from other members 12 (e.g., manage messages), view/interact with profile data 40 of related members 12 and manage relationship data 42 that defines the related members. In an embodiment, member page 74 separately classifies the related members into four classes of individuals, each of which is related to member 12 via a different set of relationships.

In particular, computer system 20 can identify all members indicated as peers of member 12 in relationship data 42, and classify these members, if any, as “peers” for member 12. Additionally, computer system 20 can identify all members indicated as direct portraits of member 12 in relationship data 42, and classify these members, if any, as “direct portraits” for member 12. Further, computer system 20 can identify all members indicated as peers of a peer of member 12 and classify these members, if any, as “indirect peers” for member 12. Finally, computer system 20 can identify all members indicated as direct portraits of a peer of member 12 and classify these members, if any, as “indirect portraits” for member 12.

For each classification, member 12 may have different privileges for interacting with members of the classification as discussed herein, which the different classifications can make clear to member 12. Alternatively, member 12 may have the same privileges for two or more classifications (e.g., “indirect portraits” and “indirect peers”). Further, the relationship to members of each classification are generally less direct/more tenuous as the classes go from “peers” (most direct) to “indirect portraits” (least direct). It is understood that pages 70, 72, and 74 are only illustrative. To this extent, computer system 20 can generate pages that include similar functionality but a different look and feel. Further, computer system 20 can enable a member 12 to customize the layout of a particular page. Still further, computer system 20 can include additional information on a page, such as indicia for new information/information that has changed, access rights, and/or the like. Additionally, when sufficient screen space is available, computer system 20 can include profile data 40 (e.g., an image, name, location) on related members 12 on page 70 and/or 74. Further, computer system 20 can enable a user to view additional information (e.g., interests, career, etc.) using any solution, such as through the use of a popup window (e.g., in response to a scroll/hover over event) or the like.

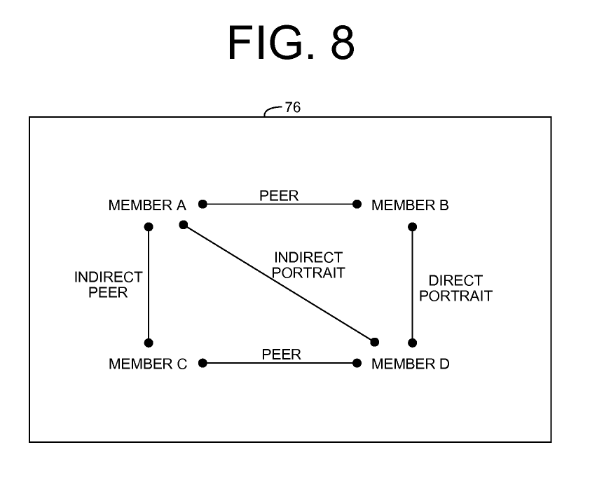

Additionally, computer system 20 can enable a member 12 to graphically view common relationships between himself/herself and another related member 12. To this extent, FIG. 8 shows an illustrative relationships page 76 according to an embodiment, which can be generated by computer system 20. In this illustrative example, MEMBER A may want to see what common relationships resulted in MEMBER D appearing as an indirect portrait. In response, computer system 20 can analyze relationship data 42 and generate relationships page 76. In reviewing relationships page 76, MEMBER A would determine that MEMBER D is an indirect portrait as a result of their respective relationships with MEMBER B. In addition, MEMBER A would determine that both members have a relationship with MEMBER C.

It is understood that various other functionality can be implemented by computer system 20 (FIG. 1). For example, computer system 20 can enable a member 12 (FIG. 1) to alter the default communication/viewing permissions that are directly and/or indirectly granted when invitee credentials 44 (FIG. 1) are provided, an exchange occurs, and/or the like. Further, when minors are allowed to be members, computer system 20 can relate one or more members with a guardian/parent member. The guardian/parent member can further restrict an ability of the member's profile to be viewed by one or more other members, monitor the exchanges that occur that impact the extent to which the member's profile is viewable, monitor/modify the member's profile, and/or the like. For example, when the member receives, generates, and/or is indirectly impacted by (e.g., as a peer) an invitation for an exchange, the guardian/parent member can be informed of the invitation and block the invitation and/or partially restrict the effect of the invitation (e.g., the member does not appear as a peer to the invitee).

While shown and described herein as a method and system for providing a network environment, it is understood that aspects of the invention further provide various alternative embodiments. For example, in one embodiment, the invention provides a computer program stored on at least one tangible computer-readable medium, which when executed, enables a computer system to provide a networking environment. To this extent, the computer-readable medium includes program code, such as networking program 30 (FIG. 1), which implements some or all of the process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; paper; and/or the like. Further, a copy of the program code can be transitory, e.g., embodied in a modulated data signal having one or more of its characteristics set and/or changed in such a manner as to encode information in the signal.

In another embodiment, the invention provides a method of providing a copy of program code, such as networking program 30 (FIG. 1), which implements some or all of a process described herein. In this case, a computer system can generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program embodied in at least one computer-readable medium. In either case, the set of data signals can be transmitted/received using any type of communications link.

In another embodiment, the invention provides a method of generating a system for providing a networking environment. In this case, a computer system, such as computer system 20 (FIG. 1), can be obtained (e.g., created, maintained, made available, etc.) and one or more programs/systems for performing the process described herein can be obtained (e.g., created, purchased, used, modified, etc.) and deployed to the computer system. To this extent, the deployment can comprise one or more of: (1) installing program code on a computing device from a computer-readable medium; (2) adding one or more computing devices to the computer system; and (3) incorporating and/or modifying the computer system to enable it to perform the process described herein.

It is understood that aspects of the invention can be implemented as part of a business method that performs the process described herein on a subscription, advertising, and/or fee basis. That is, a service provider could offer to provide a networking environment as described herein. In this case, the service provider can manage (e.g., create, maintain, support, etc.) a computer system, such as computer system 20 (FIG. 1), that performs the process described herein for one or more customers (e.g., member 12 in FIG. 1). In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of providing a networking environment, the method comprising:
managing data for a plurality of members, each member including profile data that cannot be viewed by other members without a relationship between the members;
receiving invitee credentials for viewing profile data of a first member from a second member;
enabling the second member to view the profile data of the first member in response to the invitee credentials; and
enabling a third member to view the profile data of the first member in response to the invitee credentials, wherein relationship data defines the third member as a peer of the second member.

2. The method of claim 1, further comprising generating a profile page for the first member in response to a request from one of: the second member or the third member, the profile page including profile data on the first member.

3. The method of claim 1, further comprising generating a peer page for the first member in response to a request from one of: the second member or the third member, wherein the peer page includes profile data for each of a set of members defined as peers of the first member in the relationship data.

4. The method of claim 1, further comprising generating the invitee credentials in response to a request from the first member, and providing the invitee credentials to the first member.

5. The method of claim 4, wherein the invitee credentials remain valid for a limited period of time after at least one of: the generating or a first use of the invitee credentials.

6. The method of claim 1, further comprising managing communications between the plurality of members, wherein members that are peers can communicate with one another using the networking environment.

7. The method of claim 1, further comprising generating a portrait page for the second member, wherein the portrait page includes profile data for the first member based on the invitee credentials.

8. The method of claim 1, further comprising generating a portrait page for the third member, wherein the portrait page includes profile data for the first member based on the invitee credentials.

9. The method of claim 1, wherein the invitee credentials comprise an invitation to exchange profiles, the method further comprising:
receiving an acceptance of the invitation from the second member;
adding a portrait profile for the second member to the profile data of the first member and each of a set of peers of the first member in response to the acceptance;
adding a portrait profile for the first member to the profile data of the second member and each of a set of peers of the second member in response to the acceptance;
enabling the set of peers of the first member to view profile data for the second member and the set of peers of the second member in response to the acceptance; and
enabling communications between the first member and the second member in response to the acceptance.

10. The method of claim 9, further comprising:
receiving a request from one of the first member or the second member to change a classification of the other of the first member or the second member to a peer;
requesting permission from the other of the first member or the second member to change the classification in response to the request; and
performing one of:
storing relationship data indicating that the first member and the second member are peers of one another in response to the other of the first member or the second member agreeing to the change; or
denying the request in response to the other of the first member or the second member not agreeing to the change.

11. The method of claim 9, further comprising:
receiving a request to terminate the exchange from one of the first member or the second member; and
removing the first member and the second member from the profile data for the other of the first member and the second member.

12. The method of claim 11, further comprising removing the first member and the second member from the profile data for each peer of the first member and each peer of the second member for which there does not exist an alternative set of relationships that result in the first member or the second member appearing in the profile data for the peer.

13. A system for providing a networking environment, the system comprising:
a component configured to manage data for a plurality of members, each member including profile data that cannot be viewed by other members without a relationship between the members;
a component configured to receive invitee credentials for viewing profile data of a first member from a second member;
a component configured to enable the second member to view the profile data of the first member in response to the invitee credentials; and
a component configured to enable a third member to view the profile data of the first member in response to the invitee credentials, wherein relationship data defines the third member as a peer of the second member.

14. The system of claim 13, further comprising a component configured to generate a page based on the data for the first member in response to a request from one of: the second member or the third member, the page including at least one of: profile data on the first member or profile data for each of a set of members defined as peers of the first member in the relationship data.

15. The system of claim 13, further comprising a component configured to manage communications between the plurality of members, wherein members that are peers can communicate with one another using the networking environment.

16. The system of claim 13, wherein the invitee credentials comprise an invitation to exchange profiles, the system further comprising:
a component configured to receive an acceptance of the invitation from the second member;
a component configured to store relationship data indicating that the first member and the second member are direct portraits of one another in response to the acceptance;
a component configured to enable the set of peers of the first member to view profile data for the second member and the set of peers of the second member in response to the acceptance; and
a component configured to enable communications between the first member and the second member in response to the acceptance.

17. A computer program comprising program code stored on a computer-readable medium, which when executed, enables a computer system to implement a method of providing a networking environment, the method comprising:
managing data for a plurality of members, each member including profile data that cannot be viewed by other members without a relationship between the members;
receiving invitee credentials for viewing profile data of a first member from a second member; and
storing relationship data indicating that the first member is a direct portrait of the second member, wherein the relationship data enables the second member to view the profile data of the first member, and enables a third member to view the profile data of the first member, wherein relationship data defines the third member as a peer of the second member.

18. The computer program of claim 17, the method further comprising generating a page based on the data for the first member in response to a request from one of: the second member or the third member, the page including at least one of: profile data on the first member or profile data for each of a set of members defined as peers of the first member in the relationship data.

19. The computer program of claim 17, wherein the invitee credentials comprise an invitation to exchange profiles, the method further comprising:
receiving an acceptance of the invitation from the second member;
storing relationship data indicating that the first member and the second member are direct portraits of one another in response to the acceptance, wherein the relationship data enables the set of peers of the first member to view profile data for the second member and the set of peers of the second member, enables the set of peers of the second member to view profile data for the first member and the set of peers of the first member, and enables communications between the first member and the second member.

20. The computer program of claim 17, the method further comprising:
receiving a request from one of the first member or the second member to change a classification of the other of the first member or the second member to a peer;
requesting permission from the other of the first member or the second member to change the classification in response to the request; and
performing one of:
storing relationship data indicating that the first member and the second member are peers of one another in response to the other of the first member or the second member agreeing to the change; or
denying the request in response to the other of the first member or the second member not agreeing to the change.
